(19) United States
(12) Patent Application Publication
(10) Pub. No.: US 2007/0057217 A1
(43) Pub. Date: Mar. 15, 2007

(54) Solenoid valve

(75) Inventors: Yoshinobu Kamidate, Toyota-shi (JP); Shin Ohsuga, Anjo-shi (JP)

Correspondence Address: REED SMITH LLP, Suite 1400, 3110 Fairview Park Drive, Falls Church, VA, 22042, US

(73) Assignee: Aisin Seiki Kabushiki Kaisha

(21) Appl. No.: 11/513,166

(22) Filed: Aug. 31, 2006

(30) Foreign Application Priority Data
Sep. 13, 2005 (JP) 2005-265612

(51) Int. Cl. F16K 31/02

(52) U.S. Cl. 251/129.15

(57) ABSTRACT

A solenoid valve includes a cylindrical bobbin provided with a coil thereon, a fixed core provided through an inner periphery of the bobbin, a case provided at an outer periphery of the bobbin, the case housing the fixed core, a plunger provided facing the fixed core and being movable by a magnetic attractive force, a shaft member extended to penetrate through the fixed core, the shaft member having a first end provided with the plunger in a way that the plunger is movable integrally with the shaft member, a valve member contacting a second end of the shaft member and driven by the shaft member, a biasing member biasing the valve member, the shaft member and the plunger in a counter direction of a moving direction by the magnetic attractive force, and a plurality of magnetically attracting portions provided at the plunger.

### CROSS REFERENCE TO RELATED APPLICATIONS

This application is based on and claims priority under 35 U.S.C. §119 with respect to Japanese Patent Application No. 2005-265612 filed on Sep. 13, 2005 the entire content of which is incorporated herein by reference.

### FIELD OF THE INVENTION

The present invention relates to a solenoid valve which is applied in a hydraulic circuit.

### BACKGROUND

A known solenoid valve includes a plunger which is made of ferrous material and driven by an electromagnetic coil and a spool member which is biased by a spring and contact the plunger via a shaft (e.g., described in JP09-053742A). According to the known solenoid valve described in JP09-053742A, a spool (13) slidably included in a sleeve (11) contacts a plunger (4) via a shaft (40) at one end thereof. A return spring (14), which applies a biasing force to the spool, is supported at the other end of the spool by means of a screw plug (15).

A magnetically attracting portion is formed by the plunger and by a fixed core (2). A magnetic attractive force is primarily determined by an outer diameter of the fixed core. In order to increase the magnetic attractive force, the amount of energizing current supplied to a coil (3) may be increased. However, because supplying excessive electric current to the coil leads to a magnetic saturation and/or generating heat of the coil, increasing the amount of energizing current supplied to the coil is not an effective counter measurement.

Generally, an outer diameter of a core is increased in order to increase magnetic attractive force. However, the increase of a diameter of the core leads to increase a diameter of a coil, and thus to increase a size of a solenoid valve per se.

A need thus exists for a solenoid valve, which acquires greater magnetic attractive force without increasing a size of a diameter of a coil thereof.

### SUMMARY OF THE INVENTION

In light of the foregoing, the present invention provides a solenoid valve, which includes a cylindrical bobbin provided with a coil thereon, a fixed core provided through an inner periphery of the bobbin, a case provided at an outer periphery of the bobbin, the case housing the fixed core, a plunger provided facing the fixed core and being movable by a magnetic attractive force, a shaft member extended to penetrate through the fixed core, the shaft member having a first end provided with the plunger in a way that the plunger is movable integrally with the shaft member, a valve member contacting a second end of the shaft member and driven by the shaft member, a biasing member biasing the valve member, the shaft member and the plunger in a counter direction of a moving direction by the magnetic attractive force, and a plurality of magnetically attracting portions provided at the plunger.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross-sectional view in an axial direction of a solenoid valve according to an embodiment of the present invention.

### DETAILED DESCRIPTION

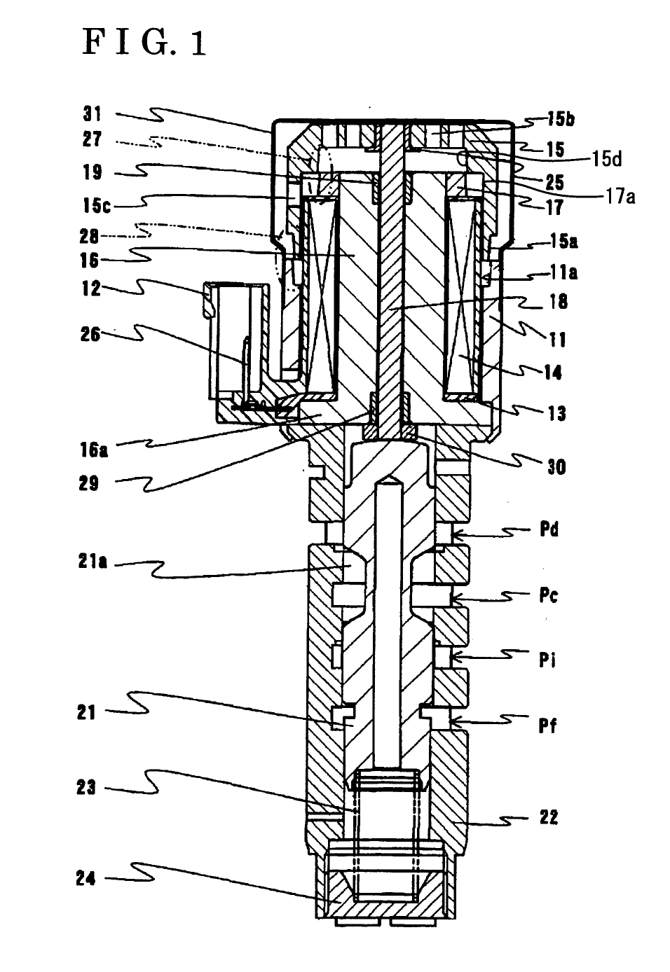

One embodiment of the present invention will be explained with reference to illustrations of a drawing figure as follows. A solenoid valve according to the embodiment of the present invention is shown in FIG. 1. According to the embodiment, the solenoid valve corresponds to a linear solenoid valve for a hydraulic pressure control apparatus for feedback control.

As shown in FIG. 1, a coil 14 which is wound around a bobbin 13 made of resin is included in a case 11. A connector 12 made of resin is fixed at a first end of the case 11. The connector 12 is electrically connected with the coil 14 and is integrally formed with a terminal 26 for electrifying the coil 14. A stepped magnetically attracting portion 11a which is thin-walled gradually is formed at a second end of the case 11.

A cylindrical front yoke (i.e., serving as a fixed core) 16 having a flange 16a at a first end thereof at the terminal side 26 is included in the bobbin 13. A ring shaped rear yoke 17 tapered at an external surface thereof and having an inner diameter which is approximately the same size with an outer diameter of the front yoke 16 is integrally press fitted to a second end of the front yoke 16 to support the coil 14.

The front yoke 16 includes a through-hole which penetrates through the center thereof. A bearing 19 is provided at the second end of the front yoke 16 and a bearing 29 is provided at the first end of the front yoke 16 to support a plunger 15 with which a shaft (i.e., serving as a shaft member) 18 is integrally press fitted to be slidable in an axial direction.

A stopper 30 is integrally provided at a tip end of the shaft 18 in order to restrict the plunger 15 from moving in the axial direction.

The plunger 15 includes an approximately cylindrical configuration having a bottom, and a tapered internal surface 15d having similar configuration with an external surface 17a of the rear yoke 17 and facing the rear yoke 17. A first magnetically attracting portion 27 is constructed between the tapered external surface 17a of the rear yoke 17 and the plunger 15. Further, at an end surface of the cylindrical portion of the plunger 15 which is arranged facing the case 11, a thin-walled tapered external surface 15a of the plunger 15 is fitted into a thin-walled tapered internal surface (i.e., a second magnetically attracting portion) 11a which is formed stepwise at the case 11 thus to form a second magnetically attracting portion 28. Upon a move of the plunger 15 against a biasing force, the tapered external surface 17a of the rear yoke 17 and the tapered internal surface 15d of the plunger 15 contact each other, and the thin-walled tapered internal surface 11a of the case 11 and the thin-walled tapered external surface 15a of the plunger 15 which faces the case 11 contact each other. The plunger 15 further includes plural through-holes 15b at the bottom and a through-hole 15c at cylindrical surface. External corner portions of the plunger 15 at opposite side relative to a surface which faces the rear yoke 17 are tapered and removed within a range which does not influence on magnetic path formation.

By removing the external corner portions of the plunger 15 and forming the through-holes 15b, 15c, mass of the plunger 15 is reduced and further, when the plunger 15 moves by means of magnetic attractive force, fluid in a void defined by the plunger 15, the rear yoke 17, and the front yoke 16 and fluid in a void defined by the plunger 15 and the bobbin 13 are discharged outside of the plunger 15 to improve an operational response of the plunger 15.

The plunger 15 is covered with a cylindrical cover 31 having a bottom keeping a predetermined clearance therebetween, and an opening portion of the cover 31 closely contact an external periphery of the case 11 to fluid-tightly seal from outside.

An approximately cylindrical sleeve (i.e., serving as a valve member) 22 contacts the flange portion 16a of the front yoke 16, and the flange portion 16a and the sleeve 22 are clinched with a thin-walled skirt portion of the case 11 to be integrally attached.

An approximately cylindrical spool (i.e., serving as a valve member) 21 is slidably included in the sleeve 22 to contact a shaft 18. A spring (i.e., serving as a biasing member) 23 is provided at a first end portion of the spool 21 which is an end portion opposite to the shaft 18 to bias the spool 21 towards the shaft 18 side.

A first end of the spring 23 is connected to the spool 21 and a second end of the spring 23 is connected to an adjuster 24 which is threadedly engaged with the sleeve 22.

An operation of the solenoid valve according to the embodiment of the present invention will be explained as follows. FIG. 1 shows a non-energized state. Under a non-energized state, although oil is supplied to a port Pi of the sleeve 22 from an oil pump, because the port Pi is closed by the spool 21, oil supply to a controlled object is stopped. In this state, hydraulic pressure is not generated at the controlled object because a port Pc which is connected to the controlled object and a drain port Pd are in communication with each other through a communication groove 21a.

When electric current is supplied to the coil 14 through the terminal 26, the plunger 15 is attracted in a direction that the external surface 17a of the tapered rear yoke 17 and the internal surface 15d of the tapered plunger 15 contact and in a direction that the external surface 15a of the tapered plunger 15 and the stepwise thin-walled internal surface 11a of the tapered case 11 contact against a biasing force of the spring 23 by means of a magnetic attractive force generated at the first magnetically attracting portion 27 constructed between the plunger 15 and the rear yoke 17 and at the second magnetically attracting portion 28 constructed between the plunger 15 and the case 11, and the plunger 15 is moved downward in FIG. 1. Upon the move of the plunger 15, the shaft 18 pushes the spool 21 in an axial direction (i.e., downward in FIG. 1). Eventually, the plunger 15 contacts the front yoke 16 via a spacer 25 to stop moving.

In a state where the plunger 15 contacts the front yoke 16 via the spacer 25, the drain port Pd is closed by the spool 21, and communication between the port Pi and the port Pc of the sleeve 22 is established through the communication groove 21a. Oil supplied to the port Pi is supplied to the controlled object from the port Pc of the sleeve 22 through the communication groove 21a to control the controlled object by hydraulic pressure.

A part of oil supplied to the controlled object affects a port Pf through a hydraulic circuit to maintain an outputted hydraulic pressure at a desired level by balancing a magnetic attractive force and a biasing force of the spring as a feedback pressure.

Namely, by applying electric current to the coil 14 through the terminal 26, the solenoid valve (e.g., linear solenoid valve) serves as a hydraulic pressure control valve having a feedback control performance which supplies hydraulic pressure supplied from the port Pi to a controlled object through the port Pc.

According to the embodiment of the present invention, because the plural magnetically attracting portions are provided at the plunger, magnetic attractive force is increased without increasing a diameter of a coil compared to known plungers which includes a magnetically attracting portion at a single position, and thus an operational response of the plunger is improved.

According to the embodiment of the present invention, because the first magnetically attracting portion is provided between the plunger and the fixed core (e.g., the rear yoke) and the second magnetically attracting portion is provided between the plunger and the case, the plunger can be attracted in an axial direction.

According to the embodiment of the present invention, because the through-hole which extends in a radial direction is formed through the cylindrical portion of the plunger having approximately cylindrical configuration with a bottom, fluid in the void defined by the plunger and the bobbin is likely to be discharged outside, and a response of the plunger is increased accordingly.

According to the embodiment of the present invention, because at least a portion of the plunger at backside thereof relative to the fixed core (e.g., rear yoke), which does not affect the forming magnetic path, is removed, mass of the plunger is reduced, and an operational response by the magnetic attractive force can be improved.

According to the embodiment of the present invention, because the valve member includes the spool which contacts the shaft member (e.g., shaft) and the sleeve which slidably includes the spool, and further because the biasing member (e.g., spring) provided in the sleeve biases the spool towards the shaft, a linear solenoid valve with a small diameter can be provided.

According to the embodiment of the present invention, because the second magnetically attracting portion is formed between the open end of the cylindrical portion of the plunger configured in approximately cylindrical having a bottom and the open end at the plunger side, it is not required to increase a diameter of the plunger.

According to the embodiment of the present invention, because the magnetically attracting portions are tapered, magnetically attracting force is likely to be constant relative to a stroke of the shaft.

The principles, preferred embodiment and mode of operation of the present invention have been described in the foregoing specification. However, the invention which is intended to be protected is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A solenoid valve, comprising:
a cylindrical bobbin provided with a coil thereon;
a fixed core provided at an inner periphery of the bobbin;
a case provided at an outer periphery of the bobbin, the case housing the fixed core;
a plunger provided facing the fixed core and being movable by a magnetic attractive force;
a shaft member extended to penetrate through the fixed core, the shaft member having a first end provided with the plunger in a way that the plunger is movable integrally with the shaft member;
a valve member contacting a second end of the shaft member and driven by the shaft member;
a biasing member biasing the valve member, the shaft member and the plunger in a counter direction of a moving direction by the magnetic attractive force; and
a plurality of magnetically attracting portions provided at the plunger.

2. The solenoid valve according to claim 1, wherein
the magnetically attracting portion includes a first magnetically attracting portion formed between the plunger and the fixed core, and a second magnetically attracting portion formed between the plunger and the case.

3. The solenoid valve according to claim 1, wherein
the plunger is formed with at least a through-hole,

4. The solenoid valve according to claim 1, wherein
at least a portion of an externally peripheral end portion of the plunger, which does not affect forming a magnetic path, is chamfered.

5. The solenoid valve according to claim 1, wherein
the valve member includes a spool which contacts the shaft member and a sleeve which is slidably provided with the spool therein; and
the biasing member provided in the sleeve biases the spool towards the shaft.

6. The solenoid valve according to claim 2, wherein
the plunger has an approximately cylindrical configuration with a bottom; and
the second magnetically attracting portion is formed between an open end of a cylindrical portion of the plunger and an open end at the plunger side of the case.

7. The solenoid valve according to claim 2, wherein
the first magnetically attracting portion includes a tapered internal surface provided at the plunger and a tapered portion provided at an externally peripheral end portion of the fixed core.

8. The solenoid valve according to claim 2, wherein
the second magnetically attracting portion is formed by a tapered external surface of the plunger opposing to the case and a tapered internal surface formed in the case.
